(19) United States
(12) Patent Application Publication
(10) Pub. No.: US 2004/0078572 A1
(43) Pub. Date: Apr. 22, 2004

(54) Method of validating performance of a participant in an interactive computing environment

(76) Inventors: Siani Lynne Pearson, Bristol (GB); Andrew Patrick Norman, Bristol (GB)

Correspondence Address: HEWLETT-PACKARD COMPANY, Intellectual Property Administration, P.O. Box 272400, Fort Collins, CO, 80527-2400, US

(21) Appl. No.: 10/632,135

(22) Filed: Jul. 30, 2003

(30) Foreign Application Priority Data
Jul. 31, 2002 (GB) 0217779.8

(51) Int. Cl. H04L 9/00

(52) U.S. Cl. 713/170; 713/161

(57) ABSTRACT

A cheat detection facility is provided in which integrity challenges are issued to a game participant seeking to ensure that the participant is not running any patches or other executable code to augment his performance in the game. The player cannot participate further in the game if an integrity check is failed.

### FIELD OF THE INVENTION

The present invention relates to a method of validating the performance of a participant in an interactive computing environment, such as an interactive game.

### BACKGROUND OF THE INVENTION

Internet technology has made it possible for games players to engage in interactive games with other players who are geographically remote from them. Indeed, several companies make money at present by hosting servers running real time interactive games that have multiple players playing against each other.

The money can be raised by advertising revenue and/or by players paying to take part. The games reward the ultimate winner with a prize. The monetary value of these prizes may be quite significant.

The problem with interactive games is that of cheating. The cheating player can have an unfair advantage over fellow players and exploit this to win the game. Cheating is possible because, in general, games engines are written so that a given game can be added to by other programmers in order to add extra levels and hence provide a more interesting gaming experience for the game players. A consequence of this desire to improve the game is that knowledge becomes available about which parameters of the game can be altered in order to control entities within the game. This knowledge can be exploited in order to write software “patches” that can be applied in order to modify operation of the game. In general, these patches are applied in order to make someone else's game much easier to play. In the interactive environment, the games are run on a central server with periodic exchange of information to the participants machines in order to allow different players to play the same game. Restrictions on communications bandwidth available over dial-up telephone lines means that only a limited amount of information could be passed between the participants machine and the server and hence the data has to be parameterised, and an application runs on the participants machine in order to interpret this parameterised information and convert it to a suitable games playing interface. Thus, information concerning the game map, and moves and character identities of other participating players will be exchanged with the game application on the participant's machine and this information will be used by the games application within the machine in order to generate a representation of the game. A problem with this scheme is that a patch can be applied locally in order to alter settings on a local client, ie on the participant's machine, and thereby to allow cheating. The patches are either written by the cheater, who keeps such information to himself, or alternatively are distributed between cheats.

### SUMMARY OF THE INVENTION

According to a first aspect of the present invention there is provided a method of validating the performance of a participant in an interactive computing environment, comprising issuing a first challenge to a participant's computing device to determine whether the participant's computing device is trustworthy, and if it is then issuing a second challenge to test the integrity of an application run on the participant's computing device, and then making a decision about the participant's involvement in the computing environment.

It is thus possible to allow a game's provider to detect the presence of software augmenting a player's performance and thereby remove such a player from the game. This is important as not only should a cheating player not be allowed to continue to participate in a game for moral reasons, but also the presence of a cheat may harm the revenue stream of the game's service provider since other players may eventually feel disadvantaged and will therefore withdraw from the game themselves, effectively making that game unplayable.

The first challenge seeks to determine the trustworthiness of the computing environment within the participant's computing device. Existing software-based security services make the implicit assumption that the platform (computing device) upon which they are running is trustworthy. In other words, they provide application level security on the assumption that they execute in a safe computing environment. However, it will be realised that this is not necessarily true. Consider, for example, a general purpose PC computer. Upon boot-up, the machine will initially execute code from its BIOS. The BIOS is stored in non-volatile memory. In the early days of computing the non-volatile memory was not re-writable. However, this is no longer the case and the use of EPROM semiconductor technologies allow for the possibility of the BIOS to be modified. Upon successful execution of the BIOS routines associated with the booting of a computer, the computer then proceeds to load the operating system. In general the operating system is stored on a mass storage device, such as a magnetic disc, and hence the possibility exists for the operating system to be examined and modified. Furthermore, even if the BIOS and operating system are not tampered with, other applications may be run on the computer in order to create a virtual machine environment in which the input and output of an unmodified application, such as a game, may be monitored by a further application, such as a cheat program, and the data tampered with on its path between the game application and the remote game server.

Methods of confirming that a computer has loaded into a known and trusted state have been published. See, for example, the paper entitled “TCPA Design Philosophies and Concepts, version 1.0” and subsequent revisions thereof including version 1.1 published by the Trusted Computing Platform Alliance (TCPA) on 25th Jan. 2001 and which at the time of writing was available on the web site www.trustedpc.org or www.trustedcomputing.org. “TCPA” and “TCPA standard” shall be used in this specification to refer not only to the TCPA version 1.1 standard, but all succeeding versions of this standard and derivations thereof, such as the specifications developed by the Trusted Computing Group.

Preferably a check is made to determine that the BIOS of the computing device is trustworthy. Preferably a check is also made to determine that the operating system of the computing device is trustworthy. Tests for determining that the BIOS and operating system are trustworthy are disclosed in the “TCPA Design Philosophies and Concepts” document and further information is available from the “TCPA PC Specific Implementations Specification, version 1.0” published on 9th Sep. 2001 at www.trustedpc.org or www.trustedcomputing.org.

Advantageously the challenge further interfaces with the operating system of the participant's computing device to determine whether or not the application, such as the game, is run within its own compartment. A compartment does not allow software running outside of the compartment to effect the running of software within the compartment.

Advantageously if, as a result of such a challenge, it is determined that the participant is not running the game within a compartment on a trusted computing platform, or alternatively that the game is within a compartment on a trusted computing platform but that another software component is present in that compartment, then the service removes that player from the game.

The second challenge challenges the identity of an application run on a participant's computing device in order to determine the status of the application. The challenge may be run to determine whether the application, for example a game, has been modified, for example by the user applying the patch or some other unauthorised modification to the game.

The challenge may include checks for signatures of known patches, checks made on the names of routines used within the game, and checks on the lengths, and/or check sums of some of the application components. Depending on the implementation of the game, the components may include executable files, binary files, library files or applets, this list is to be considered illustrative only and is not exhaustive.

Preferably a monitoring agent for monitoring a player's performance is run on the participant's computing device. The monitoring agent may advantageously monitor the game play in order to determine that rules of causality are obeyed and/or that response times are not unbelievably fast. In a game, it is possible that one player may launch an attack on another player. If rules of causality are obeyed, then the attacked player can only respond to the attack after the attack has been initiated and also after sufficient game play has occurred for the attacked player to be able to observe that an attack is under way. If, however, a player manages to respond to an attack instantaneously, or indeed before, such an attack is displayed to that player then the rules of causality are broken and it can be inferred that some form of cheat software is in operation. This protects players against the use of cheat software launched after a player has initially logged on to the game service or by a player playing the game via a proxy server whose participation in the game play only becomes evident some time after the game log on has been completed.

The monitoring agent is advantageously protected against alteration or spoofing of its messages, for example by using cryptography to send encrypted messages, and the messages from the monitoring agent are trusted because its integrity is periodically checked via the TCPA integrity checking mechanisms.

The monitoring agent may be launched at the start of a game and remain only as long as the game is played itself, or could be launched at initial registration of the play with the game providing company and remain for the duration of that player being registered with the game or with the game provider.

Advantageously game progress logs are recorded by both the game server and the game client and information within these logs is periodically exchanged and cross-correlated in order to confirm that the game is played within expected parameters.

According to a second aspect of the present invention there is provided a method of validating the performance of an entity in a first computing environment, comprising issuing a challenge to determine if a computing environment of the entity is trustworthy and to determine the integrity of an application run in the entity's computing environment, and making a decision concerning the entities rights in the first computing environment based on the results of the challenge.

Thus a combined challenge may be issued.

Advantageously subsequent challenges may be periodically made in order to reverify the trust that is placed in the entity's computing environment and/or the integrity of applications or processes run therein.

The entity may be another computer requiring the performance of a task or it may be a person (user) who wishes to participate in an environment, such as a computer game (ie virtual environment) via their own or someone else's machine.

According to a third aspect of the present invention there is provided a server for validating the performance of a participant in an interactive computing environment, wherein the server is arranged to issue a first challenge to a participant's computing device to determine whether the participant's computing device is trustworthy, and if it is to then issue a second challenge to test the integrity of an application run on the participant's computing device, and then make a decision concerning the participant's involvement in the computing environment.

According to a fourth aspect of the present invention there is provided a system for validating the performance of a participant in an interactive computing environment, comprising a first computing device arranged to issue a first challenge to a participant's computing device to determine whether the participant's computing device is trustworthy, and if it is to issue a second challenge to test the integrity of an application run on the participant's computing device, and to make a decision concerning the participant's involvement in the computing environment.

### BRIEF DESCRIPTION OF THE DRAWINGS

The present invention will further be described, by way of example, with reference to the accompanying drawings, in which:

FIG. 1 schematically represents a plurality of gamers interacting with an internet based multi-player game;

FIG. 2 schematically represents the architecture of a trusted computing platform; and

FIG. 3 is a flow chart of a challenge in accordance with the present invention.

### DETAILED DESCRIPTION OF A PREFERRED EMBODIMENT OF THE INVENTION

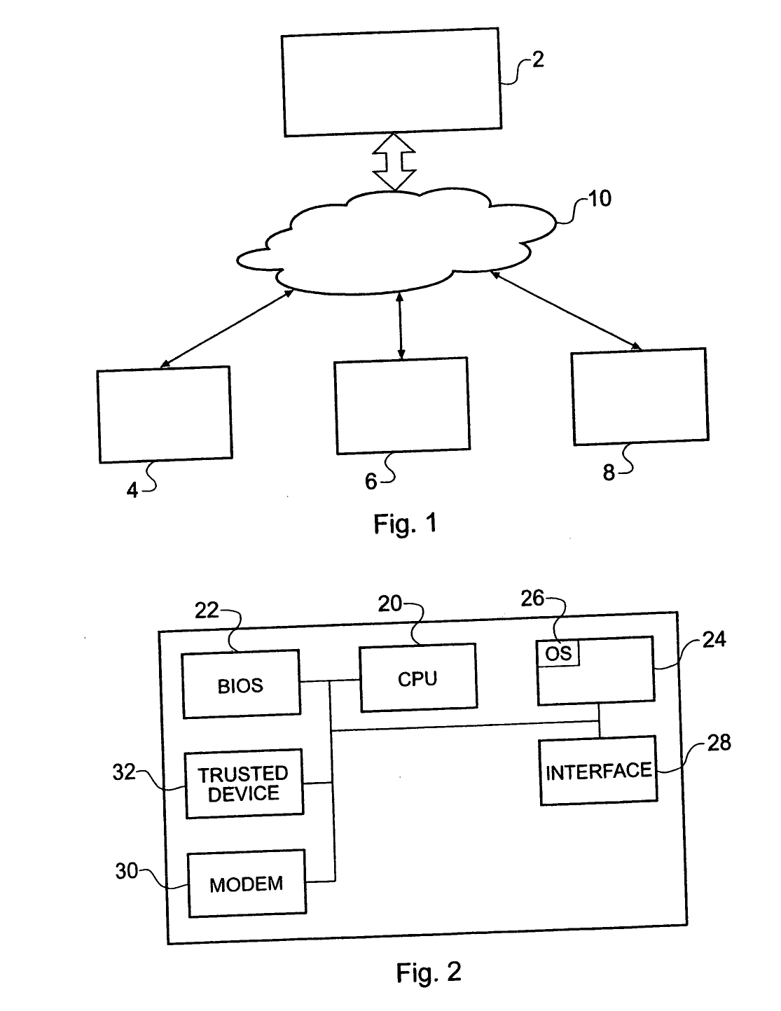

FIG. 1 schematically illustrates an interactive game play in which a game is hosted on a server 2 run by a gaming company. Players 4, 6 and 8 are connected to the server 2 via a telecommunications network 10 in order that they can participate in the game. The telecommunications network 10 may, for example, comprise the internet in combination with telecommunications links local to the players 4, 6 and 8. If the players 4, 6 and 8 interconnect using a dial-up service over standard telephone connections (plain old telephone service, POTS) then the players will suffer bandwidth restrictions and/or latency issues which effectively prevent the server 2 from being able to directly control images and/or sounds presented to the game players. In order to overcome these problems, the games server downloads a games application to each of the players 4, 6 and 8 such that parameterised game information can be passed between the games application, which functions as a client, and the games server 2. Thus each games client runs within a computing environment which is outside of the control of the games server and which may be modified by the gaming participants.

In order to protect against such cheating the server 2 issues challenges to each of the computers 4, 6 and 8 to assure itself that the game has not been modified.

In order to ensure complete integrity, the server 2 must first satisfy itself that each participating machine 4, 6 and 8 is operating in a trustworthy mode. In order to achieve this, the server 2 must be able to place its own trust in some component within the computing environment. The machines 4, 6 and 8 may be built in such a way that allows their trustworthiness to be verified. This may, for example, be achieved in accordance with the scheme disclosed via the Trusted Computing Platform Alliance. In general terms, each “trusted computer” has a tamper proof trusted device embedded within it. The trusted device can communicate data concerning its operation and metrics (integrity metrics) concerning the operation of the computing device around it to a trusted third party, or to a challenger such as the game server, in an encrypted form. Other devices/service providers can then ask the trusted third party to vouch for the trustworthiness of the computer containing the trusted device or the challenger can ask a trusted third party, such as a certification authority, to tell it what the integrity metric for the challenged computing device should be. The challenger can then verify if the trusted device is functioning as expected. If so, then a “root of trust” has been established.

The trusted device can be trusted since its internal processes cannot be subverted. It can then monitor the build of the computer following boot-up in order to ensure that the BIOS modules are as expected and thereby to be able to authenticate that the BIOS is operating correctly. From then on, the trusted device can itself, or in combination with the BIOS, seek to challenge the operating system as it builds the operating environment in order to ensure that the operating system is itself functioning correctly. From then on, attempts to modify the operating system or the BIOS can be detected. Thus at each level of build of the computing environment, a measure of the trust in the component (both hardware and software) forming that environment can be made and compared by the challenger with a measure it obtains from a certification authority—which by definition is trusted.

Once the operating system is trusted, it then becomes possible to launch a challenge to the games client in order to check that patches or other modifications have not been applied to it. This can be performed by looking for signatures of well known patches and/or checking the revision dates, lengths and check sums of components used by the game client. The challenge may be launched via the Trusted Computing Platform Alliance integrity check mechanism and hence the results of the challenge can themselves be trusted. If the challenge determines that the computing platform is not trusted, or that the game has been modified, then the server removes the player from the game.

Thus now it becomes possible to confirm that the challenge to the games client is now operating correctly and that the results of the challenge to the game can themselves be trusted.

It is possible that a player may seek to run additional software on a trusted computing platform which monitors the data communication with an unmodified game and seeks to modify this communication in order to give the player an advantage. This problem can be overcome by making sure that the game runs within its own compartment within the operating system, the compartment serving to make sure that no other program can modify the running of the game or the exchange of data to and from the game. Thus, optionally, the game operator can perform a check to see whether the game client is being run within its own compartment and if not, the server 2 may remove the player from the game.

The server may also detect the response times of a gamer who is performing well and perform statistical analysis to see whether the player's performance has been augmented. Checking agents may be run on the server, on the participant's computing device or on both.

When a performance monitoring agent is run on the participant's machine the monitoring agent can check a player's response time to various actions within the game and can inform the server when the player is playing statistically better than might normally be expected. The monitoring agent may be run within a trusted computing environment and may obviate the need to run the game within a compartment. The output from the monitoring agent is encoded so that its data cannot be altered or spoofed, thereby ensuring that the monitoring agent is trustworthy. In the result of a report by the monitoring agent suggesting that the player seems to be cheating, or the absence of reports from the monitoring agent, the player may be removed from the game.

FIG. 2 schematically illustrates the configuration of a trusted computing device. The device includes a central processing unit 20, a non-volatile memory 22 holding the BIOS, a bulk storage device 24 including the operating system 26, an interface 28 for allowing the device to interface with the user, a modem 30 for allowing interconnection with the remote server 2 and a trusted device 32 whose authenticity and integrity underpins the ability to trust the user device. As noted before, at boot-up the trusted device 32 interrogates the BIOS 22 to check that it has not been tampered with. If the BIOS has not been tampered with the trusted device in combination with the trusted BIOS allows the operating system 26 to be built and to ensure that the integrity of the operating system components are checked during the installation of the operating system. If the operating system has not been tampered with then the trusted device can authenticate, when challenged, that the computer is trustworthy, ie that it is a trusted platform. However, if either the BIOS or the operating system fails its integrity challenge then the trusted device is not in a position to authenticate that the computer is trustworthy.

At each stage a log of the integrity metrics, that is to say a record of response or answers to the procedures used to measure the integrity of the computing system is kept by the trusted device.

When a player joins a game, the player seeks to establish communication with the server using the modem 30 and issues instructions for game play via the interface 28. At commencement of the game, and periodically during the game, the server 2 can challenge the integrity of the participant's machine in order to determine that additional cheating software has not been run.

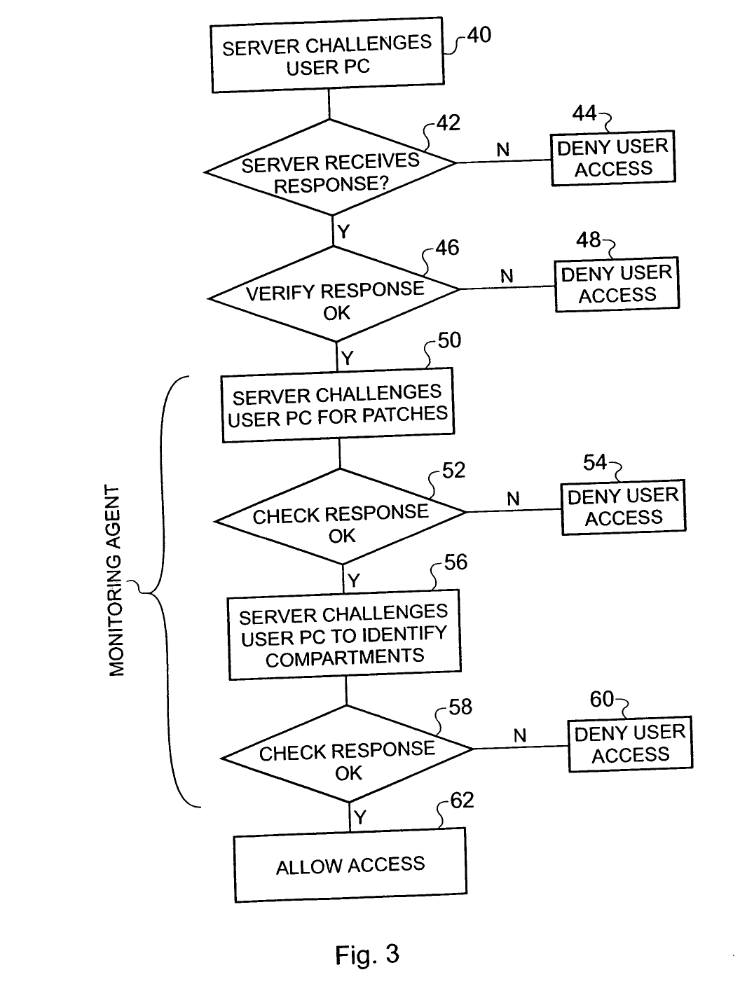

FIG. 3 schematically illustrates a challenge and response sequence during player log on to a computing or participate in a computing environment, which in this example is a game.

The challenge commences at step 40 whereby, in response to a user's, or potential users, request to join the game the server issues a challenge to the user's computer to see if it is a “trusted platform”. The server seeks to establish communication with the trusted component. The trusted component has several secrets stored within it which are known only to it and to a certification authority. In response to the challenge the trusted component can release its secret in an encrypted form to the server. The server can then seek certification from the certification authority that the trusted component is what it claims to be. The response from the trusted component may also include a list of the BIOS, operating system and applications that have been invoked since boot up, or which are active, together with an integrity metric (such as a check sum) such that the software build can be checked. This information is signed by the trusted component in order to validate it and can be passed to the server in encrypted form using either a key as negotiated with the server for this purpose or using a key known only to the certification authority. If this latter route is chosen then the server needs to contact the certification authority to get the information decrypted.

After step 40, control passes to step 42 where the server checks to see if it has had a response to the integrity challenge. If a response is not received within a time out period then control is passed to step 44 where the user is denied access. However, if a response is received, then control passes to step 46 where the response is verified. If the response is not correct control passes to step 48 where access is denied, otherwise control passes to step 50 where now it has been established that the computer's operation has not been subverted, a challenge is made to see if any software cheats (patches, utilities etc) are running. From step 50, control is passed to step 52 where the response to challenge from step 50 is analysed. The analysis may include calculation of correct checksums and the like. These responses are then compared with the correct answers to the challenges. The correct answers may be validated as correct by a trusted certification authority. If the challenge is failed then control passes to step 54 where the user is denied access to the service. However, if the integrity challenge of the game operation (or that the executable code for the game is correct) then control proceeds to step 56 where a further challenge is issued to see if the game is being run within a compartment such that it's operation cannot be affected by other computer programmes (which might be malicious) running on an otherwise trusted machine. If, in response to the test for compartments it is determined that compartments are not being run or observed then control is passed to step 60 where the user is denied access, otherwise control is then passed to step 62 where the user is allowed access.

In the above process the challenges and responses may be made in, for example accordance with the TCPA standards (see the trusted computing platform alliance web site).

Steps 50, 52, 54, 56, 58, 60 and 62 may be performed by a monitoring agent that is loaded onto and run on the user's computing device.

Although in the example of FIG. 3, any failure in the integrity challenge scheme has met with denial of service to the user, this is not the only option. The service provider could still allow the user to log on and participate, but the user may be monitored more carefully or parameters of the service that he or she received may be altered.

Although the present invention has been described in the context of the player's computer being a trusted device, it is possible to provide a degree of protection against cheating even if the player's computer is not a trusted computing device. Challenges can still be launched concerning the integrity of the computer code for the game (or indeed any other application) and these can still have considerable use provided that the result of the challenge has not been determined by the cheats or other people trying to subvert the computing progress.

The server 2 and the game client can each keep a log of the game play and the client log, or at least portions of it, may be sent to the server, either periodically or upon request, in order that the logs can be checked against one another. Naturally, the logs should match, and any discrepancy provides evidence of cheating. The logs will typically include a list of the actions or instructions passed between the server and the game client. The events are advantageously associated with a time—either with reference to a mutually agreed time or elapsed time from the previous event. These times should correlate, and failure of the times to correlate may point to the existence of a cheat programme or the use of a player augmentation server.

It is thus possible to provide an authentication service for validating that a games application is running correctly and has not been tampered with.

Up to now, the challenge has been described as two challenges performed sequentially. However, without loss of functionality, a single challenge seeking responses to questions relating to integrity/trust of the computing environment and the operation of a process or application therein can be issued, and a decision concerning the rights or continued participation of a user can be taken in view of the response received.

The provision of and verification of a trusted environment also may be beneficial.

1. A method of validating the performance of a participant in an interactive computing environment, comprising issuing a first challenge to a participant's computing device to determine whether the participant's computing device is trustworthy, and if it is then issuing a second challenge to test the integrity of an application run on the participant's computing device, and then making a decision concerning the participant's involvement in the computing environment.

2. A method as claimed in claim 1, in which the second challenge tests for modification of the application.

3. A method as claimed in claim 1, in which the second challenge tests for a signature of at least one known patch.

4. A method as claimed in claim 1, in which the second challenge checks at least one of the names, lengths and check sums of components of the application.

5. A method as claimed in claim 1, in which in the first challenge the trustworthiness of the BIOS is validated.

6. A method as claimed in claim 5, in which in the first challenge the trustworthiness of the operating system is validated.

7. A method as claimed in claim 1, in which a check is made to determine if the application is being run within a suitably protected compartment.

8. A method as claimed in claim 1 in which a monitor agent for monitoring player's performance is run on the participant's computing device.

9. A method as claimed in claim 8, in which the monitor agent checks user responses to events in order to estimate whether the user's responses have been augmented.

10. A method as claimed in claim 9, in which the monitor agent reports to a server.

11. A method as claimed in claim 1, in which the challenge is issued by a server with which the participants computing device is in communication.

12. A method as claimed in claim 1, in which the interactive computing environment comprises a game.

13. A method as claimed in claim 1, in which the first challenge is in accordance with a TCPA standard.

14. A method of validating performance of a participant in an interactive computing environment, comprising issuing a challenge to a participant's computing device and on the basis of the challenge making a decision about allowing the participant to participate in the interactive computing environment, wherein the challenge comprises a machine challenge using procedures set out in a TCPA standard to determine that the participant's computing device is operating in a trustworthy manner, and an application challenge which tests the integrity of the application run on the participant's computing device.

15. A method of validating the performance of an entity in a first computing environment, comprising issuing a challenge to determine if a computing environment of the entity is trustworthy and to determine the integrity of an application run in the entity's computing environment, and making a decision concerning the entities rights in the first computing environment based on the results of the challenge.

16. A computer program for causing a programmable data processor to execute the method of any one of claims 1, 14 and 15.

17. A server for validating the performance of a participant in an interactive computing environment, wherein the server is arranged to issue a first challenge to a participant's computing device to determine whether the participant's computing device is trustworthy, and if it is to then issue a second challenge to test the integrity of an application run on the participant's computing device, and then make a decision concerning the participant's involvement in the computing environment.

18. A server as claimed in claim 17, in which the second challenge tests for modification of the application.

19. A server as claimed in claim 17, in which the second challenge tests for a signature of at least one known patch.

20. A server as claimed in claim 17, in which the second challenge checks at least one of the names, lengths and check sums of components of the application.

21. A server as claimed in claim 17, in which in the first challenge the trustworthiness of the BIOS and of the operating system is validated.

22. A server as claimed in 17, in which a check is made to determine if the application is being run within a suitably protected compartment.

23. A system for validating the performance of a participant in an interactive computing environment, comprising a first computing device arranged to issue a first challenge to a participant's computing device to determine whether the participant's computing device is trustworthy, and if it is to issue a second challenge to test the integrity of an application run on the participant's computing device, and to make a decision concerning the participant's involvement in the computing environment.

24. A system as claimed in claim 23, in which the second challenge tests for modification of the application.

25. A system as claimed in claim 23, in which the second challenge tests for a signature of at least one known patch.

26. A system as claimed in claim 23, in which the second challenge checks at least one of the names, lengths and check sums of components of the application.

27. A system as claimed in claim 23, in which in the first challenge the trustworthiness of the BIOS of the operating system is validated.

28. A system as claimed in claim 23, in which a check is made to determine if the application is being run within a suitably protected compartment.

29. A system as claimed in claim 23, in which a monitor agent for monitoring player's performance is run on the participant's computing device.

30. A system as claimed in claim 29, in which the monitor agent checks user responses to events in order to estimate whether the user's responses have been augmented.

31. A system as claimed in claims 23, in which the first computing device is a server with which the participant's computing device is in communication.

32. A system as claimed in claim 31, in which the monitor agent reports to a server.

33. A system as claimed in claim 31, in which the server is hosting a game and the participant is attempting to play the game.

34. A system as claimed in claim 23, in which the first challenge is in accordance with a TCPA standard.

35. A system for validating performance of a participant in an interactive computing environment, comprising a server for issuing a challenge to a participant's computing device and on the basis of the challenge making a decision about allowing the participant to participate in the interactive computing environment, wherein the challenge comprises a machine challenge using procedures set out in a TCPA standard to determine that the participant's computing device is operating in a trustworthy manner, and an application challenge which tests the integrity of the application run on the participant's computing device.
